(19) United States
(12) Patent Application Publication
(10) Pub. No.: US 2026/0359021 A1
(43) Pub. Date: Nov. 12, 2026

(54) GENERATING AND EXECUTING PARALLEL EXECUTION GRAPHS USING HUMAN READABLE PROGRAMMING LANGUAGE CODE

(71) Applicant: AI21 LABS, Tel Aviv (IL)

(72) Inventors: Barak PELEG, Givataim (IL); Shahar LEV, Modi'in (IL)

(73) Assignee: AI21 LABS, Tel Aviv (IL)

(21) Appl. No.: 19/668,102

(22) Filed: May 5, 2026

Related U.S. Application Data
(60) Provisional application No. 63/801,426, filed on May 7, 2025.

(51) Int. Cl. G06F 8/35

(52) U.S. Cl. CPC G06F 8/35

(57) ABSTRACT

A computer-implemented method includes receiving a request to perform a task and writing, in a human readable programming language, code representing an execution graph for the request. The human readable programming language code supports a functional application programming interface. The method further includes translating the human readable programming language code into the execution graph, wherein the execution graph comprises a plurality of nodes representing function calls and data dependencies between the plurality of nodes. The method further includes identifying, based on the data dependencies between the plurality of nodes, independent nodes among the plurality of nodes that do not depend on each other. The method further includes executing the independent nodes in parallel to process the request and outputting a result of the request based on the parallel execution of the independent nodes.

### CROSS-REFERENCE TO RELATED APPLICATIONS

This application claims priority to U.S. Provisional Application No. 63/801,426, filed May 7, 2025, which is hereby incorporated by reference in its entirety.

### TECHNICAL FIELD

The present disclosure relates to artificial intelligence systems and execution graph processing, and more particularly to generating and executing parallel execution graphs using human readable programming language code.

### BACKGROUND

Artificial intelligence (AI) systems have become increasingly sophisticated in their ability to process complex requests and perform a wide variety of tasks. Modern AI systems often rely on multiple models working in concert, each with different capabilities, to handle requests that require diverse types of processing or reasoning. Additionally, many requests require multi-hop reasoning, where the system must perform multiple sequential operations or model calls to arrive at a result.

As AI systems have grown in complexity, so too have the execution workflows that govern how these systems process requests. These workflows can be conceptualized as execution graphs, where nodes represent individual operations or function calls, and edges represent data dependencies between those operations. Managing these execution graphs presents numerous challenges, particularly as the graphs become larger and more intricate.

One challenge relates to the representation of execution graphs in a manner that is both machine-executable and human-understandable. Many existing approaches rely on specialized domain-specific languages or visual programming interfaces that may be difficult for developers to work with or that lack the expressiveness needed for complex workflows. Additionally, generating execution graphs manually can be time-consuming and error-prone, particularly for sophisticated AI applications.

Another challenge involves the efficient execution of these graphs. In some cases, portions of an execution graph may be independent of one another and could theoretically be executed in parallel. However, identifying these independent portions and coordinating their parallel execution can be difficult, particularly when the graph representation does not clearly expose data dependencies between operations.

Security considerations also present challenges in execution graph systems. When execution graphs are generated dynamically or include code from various sources, there is a risk that malicious or unintended operations could be executed. Ensuring that safe, authorized operations are performed requires careful validation and control mechanisms.

Furthermore, monitoring and debugging execution graphs can be difficult. Understanding how resources are being used, tracking intermediate results, and identifying where deviations from expected behavior occur are important for maintaining and improving AI systems. The ability to pause execution, inspect state, and resume or modify execution based on intermediate results or external input are other areas where existing approaches fall short.

Therefore, there is a need for improved systems and methods for generating, representing, and executing complex execution graphs in AI systems.

### SUMMARY

In an embodiment, a computer-implemented method includes receiving a request to perform a task. The method includes writing, in a human readable programming language, code representing an execution graph for the request, wherein the human readable programming language code supports a functional application programming interface. The method includes translating the human readable programming language code into the execution graph, wherein the execution graph comprises a plurality of nodes representing function calls and data dependencies between the plurality of nodes. The method includes identifying, based on the data dependencies between the plurality of nodes, independent nodes among the plurality of nodes that do not depend on each other. The method includes executing the independent nodes in parallel to process the request. The method includes outputting a result of the request based on the parallel execution of the independent nodes.

In an embodiment, a non-transitory computer readable medium includes instructions that when executed by one or more processing devices cause the one or more processing devices to perform a method. The method includes receiving a request to perform a task. The method includes writing, in a human readable programming language, code representing an execution graph for the request, wherein the human readable programming language code supports a functional application programming interface. The method includes translating the human readable programming language code into the execution graph, wherein the execution graph comprises a plurality of nodes representing function calls and data dependencies between the plurality of nodes. The method includes identifying, based on the data dependencies between the plurality of nodes, independent nodes among the plurality of nodes that do not depend on each other. The method includes executing the independent nodes in parallel to process the request. The method includes outputting a result of the request based on the parallel execution of the independent nodes.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 illustrates a block diagram of a system for generating and executing parallel execution graphs, consistent with embodiments of the present disclosure.

FIG. 2 illustrates a flowchart for a method for generating and executing parallel execution graphs, consistent with embodiments of the present disclosure.

FIG. 3 illustrates an execution graph depicting parallel execution of independent nodes, consistent with embodiments of the present disclosure.

FIG. 4 illustrates a flowchart for a method for validating human readable programming language code, consistent with embodiments of the present disclosure.

FIG. 5 illustrates a sequence diagram for a state storage and restoration process, consistent with embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Embodiments of the present disclosure provide systems, methods, and non-transitory computer-readable media for generating and executing parallel execution graphs using human readable programming language code. The disclosed embodiments may express execution graphs in a human readable programming language, such as Python, that supports a functional application programming interface without side effects. By leveraging the capabilities of large language models trained on open-source repositories and coding examples, the disclosed embodiments may enable automated generation of human readable programming language code representing execution workflows. The generated code may be translated into an execution graph where data dependencies between nodes are defined, enabling identification of independent nodes that may be executed in parallel to reduce processing time.

The disclosed embodiments may provide security guarantees by validating human readable programming language code against permissible functions prior to execution, including detection of third-party code, operating system calls, and file-system operations. The disclosed embodiments may provide traceability of execution graphs, including tracking resource utilization and intermediate results, and may support storing and restoring execution graph state to enable features such as human-in-the-loop functionality, replaying portions of execution with modifications, and early return when a valid result is available. The combination of human readability, automated generation, parallel execution, security validation, and state management may address challenges associated with representing, generating, and executing complex execution workflows in artificial intelligence systems.

Moreover, the disclosed embodiments may address technical challenges in AI execution systems that cannot be solved by human mental processes alone. Traditional approaches for executing AI workflows suffer from inefficiencies caused by sequential execution of operations that could otherwise be performed concurrently. The disclosed embodiments may automatically analyze data dependencies within execution graphs and identify independent nodes that may be executed in parallel, thereby reducing total processing time and improving computational efficiency.

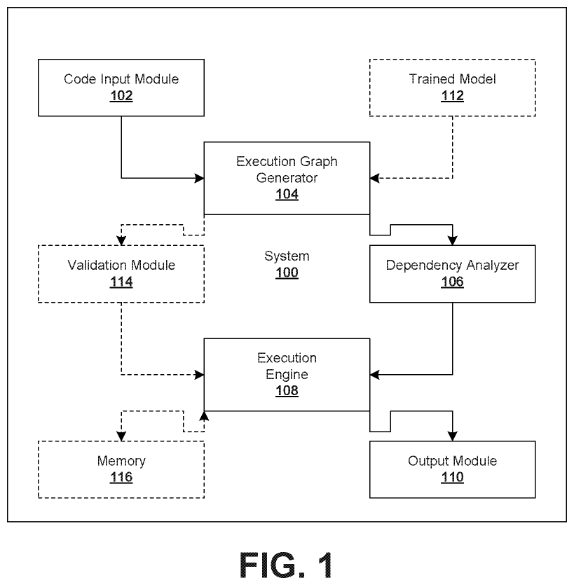

FIG. 1 illustrates a block diagram of a system 100 for generating and executing parallel execution graphs using human readable programming language code, consistent with disclosed embodiments. As shown in FIG. 1, the system 100 may include a code input module 102, an execution graph generator 104, a dependency analyzer 106, an execution engine 108, an output module 110, a trained model 112, a validation module 114, and a memory 116. One of ordinary skill in the art will recognize that, in some embodiments, functionality of one or more components of FIG. 1 may be omitted and/or combined. For example, some embodiments may omit one or more of the trained model 112, the validation module 114, and the memory 116.

The system 100 may further include one or more processors configured to execute instructions for performing operations associated with the code input module 102, the execution graph generator 104, the dependency analyzer 106, the execution engine 108, the output module 110, the trained model 112, the validation module 114, and the memory 116. The one or more processors may include one or more central processing units (CPUs), one or more graphics processing units (GPUs), one or more tensor processing units (TPUs), one or more application-specific integrated circuits (ASICs), one or more field-programmable gate arrays (FPGAs), or combinations thereof. In some embodiments, the one or more processors may comprise a multi-core processor having multiple processing cores capable of executing instructions in parallel. The one or more processors may be configured to execute instructions stored in the memory 116 to perform the operations of the system 100. In some embodiments, the system 100 may be implemented on a single computing device having one or more processors. In some embodiments, the system 100 may be implemented across multiple computing devices connected by a network, where different components of the system 100 execute on different computing devices. The one or more processors may include specialized hardware accelerators configured to accelerate execution of the trained model 112. In some embodiments, the one or more processors may include neural processing units (NPUs) or other specialized processors designed for machine learning workloads.

The system 100 may be configured to handle requests for artificial intelligence (AI) systems by processing complex execution workflows. The complexity of execution graphs may arise from the multiple calls to trained models that handle a request. In some embodiments, multiple trained models may be involved due to different capabilities of the trained models. In some embodiments, requests may be broken down due to multi-hop reasoning requirements, where the system 100 performs multiple sequential processing steps to arrive at a result.

In some embodiments, the code input module 102 may be configured to receive human readable programming language code representing an execution graph for a request. In some embodiments, the code input module 102 may receive the human readable programming language code from an external source (e.g., a trained model) or user input. In some embodiments, the human readable programming language code may comprise Python programming language code.

The human readable programming language code may support a functional application programming interface (API) without side effects. A functional API without side effects means that calls to functions can be replaced by their return value because functions do not alter any state outside of their own scope. The functional nature of the code may enable the execution graph generator 104 to translate the code into an execution graph where data dependencies between nodes are clearly defined.

A side effect may refer to any modification of state outside of a function's own scope. Examples of side effects may include modifying global variables, writing to databases, sending network requests, modifying input parameters passed by reference, printing to console or log files, and altering file system contents. In some embodiments, a function without side effects may receive input parameters and produce a return value without affecting any external state. For example, a permissible function pattern may include a function that receives two numerical inputs and returns their sum without modifying any variables outside the function scope. An impermissible function pattern may include a function that modifies a global counter variable or writes results to an external database during execution. The functional nature of the human readable programming language code may enable the dependency analyzer 106 to determine that the output of a function depends only on its inputs, which facilitates identification of independent nodes that may be executed in parallel.

In some embodiments, a trained model may generate the human readable programming language code. For example, the trained model 112 may be configured to generate or write code in a human readable programming language in response to receiving a request to perform a task. The generated human readable programming language code may define function calls, data dependencies between function calls, and control flow logic for handling the request. The generated human readable programming language code may support a functional application programming interface (API) without side effects. In some embodiments, the human readable programming language code may comprise Python programming language code.

In some embodiments, the trained model 112 may comprise a large language model (LLM). For example, the trained model 112 may be configured based on training data comprising one or more open-source repositories and examples of human readable programming language code. LLMs may be effective at generating the human readable programming language code because LLMs are trained on datasets sourced from various sources such as the internet, which include open-source repositories and coding examples.

The trained model 112 may comprise various types of machine learning models in addition to or instead of large language models. In some embodiments, the trained model 112 may comprise a transformer-based neural network architecture. The transformer architecture may include an encoder, a decoder, or both an encoder and a decoder. In some embodiments, the trained model 112 may comprise a decoder-only transformer model configured for autoregressive text generation. In some embodiments, the trained model 112 may comprise an encoder-decoder transformer model configured for sequence-to-sequence tasks.

In some embodiments, multiple trained models may process a request due to different capabilities of the trained models. For example, a first trained model may be configured for text understanding and comprehension, a second trained model may be configured for code generation, a third trained model may be configured for logical reasoning and inference, and a fourth trained model may be configured for image processing or multimodal tasks.

In some embodiments, the trained model 112 may receive a prompt that includes the request and additional context information. The prompt may include examples of human readable programming language code that demonstrate desired patterns or structures for the execution graph. The prompt may include instructions that guide the trained model 112 in generating code that conforms to the functional application programming interface supported by the system 100. In some embodiments, the prompt may include constraints or requirements that the generated human readable programming language code must satisfy.

In some embodiments, the trained model 112 may generate human readable programming language code through an iterative refinement process. For example, the trained model 112 may generate an initial version of the human readable programming language code and subsequently refine the code based on feedback or validation results. For example, the validation module 114 (discussed below in further detail) may provide feedback to the trained model 112 indicating whether the generated code conforms to the plurality of permissible functions. In response to receiving feedback indicating that the generated code does not conform, the trained model 112 may generate a revised version of the human readable programming language code.

The human readable programming language code may natively support functions for breaking complex execution graphs into sub-graphs. By defining functions within the human readable programming language code, complex execution workflows may be decomposed into smaller, modular components. Each function may represent a sub-graph that performs a specific portion of the overall execution workflow. The ability to break complex execution graphs into sub-graphs may enable the system 100 to manage and process sophisticated AI workflows in a structured manner.

The use of the human readable programming language to represent the execution graph may provide several benefits. First, the human readable programming language may be readable by human developers, enabling developers to understand, modify, and debug execution workflows without specialized tools. Second, the human readable programming language may natively support functions, which may allow breaking complex execution graphs into sub-graphs where each function represents a modular component of the overall workflow. Third, the human readable programming language may natively support control flow constructs such as if-else statements and data flow representations that define relationships between function outputs and inputs, including basic primitive manipulations. The combination of human readability, native function support, and native control flow and data flow support may enable the system 100 to represent sophisticated execution workflows in a format that is both machine-executable and accessible to developers.

In some embodiments, the system 100 may select among multiple trained models based on selection criteria to process a request. The selection criteria may include the type of task to be performed, the complexity of the request, latency requirements, cost constraints, or availability of models. The system 100 may implement model routing algorithms that analyze the request and determine which trained model is best suited to generate the human readable programming language code for the request. In some embodiments, the model routing algorithms may use classification models to categorize requests and route them to appropriate trained models. In some embodiments, the system 100 may maintain fallback models that are used when primary models are unavailable. The fallback models may be smaller or less robust models that can handle requests when primary models are experiencing high load, maintenance, or failures. The system 100 may automatically switch to fallback models when primary models fail to respond within a timeout period or return errors.

The execution graph generator 104 may receive the human readable programming language code from the code input module 102 or from the trained model 112 and may translate the human readable programming language code into an execution graph comprising a plurality of nodes representing function calls and data dependencies between the plurality of nodes. The translation process may convert the human readable programming language code into a graph structure where relationships between operations are explicitly defined.

In some embodiments, the execution graph generator 104 may derive the execution graph from implementation patterns expressed in the human readable programming language code. One such pattern is the ReAct implementation pattern, which represents a reasoning and acting paradigm for AI systems. The ReAct implementation pattern may include functions that perform iterative reasoning steps, where a system obtains a thought, determines a next action based on the thought, executes the action to produce an observation, and conditionally continues reasoning or returns a result. The execution graph generator 104 may parse the human readable programming language code implementing the ReAct pattern and may generate or write a corresponding execution graph that represents the flow of data and control through the reasoning steps.

The execution graph generated by the execution graph generator 104 may define data dependencies between nodes. For example, in the code representation (e.g., a Python code representation), data dependencies between different functions may not always be clear from the code structure alone. The graph representation generated by the execution graph generator 104 may define relationships between nodes based on data dependencies, making the dependencies explicit. The explicit representation of data dependencies may enable the dependency analyzer 106 to identify independent nodes that do not depend on each other.

In some embodiments, the ReAct implementation pattern may be expressed in the human readable programming language code using a structure where a function decorated as a flow receives a thought and thought prompt, calls a function to get a next action, executes the action to produce an observation, and conditionally returns a result or recursively continues reasoning. The human readable programming language code may include functions decorated with dynamic block indicators that construct prompts and invoke language models, and functions decorated with input/output block indicators that manage the flow of data between reasoning steps. The execution graph generator 104 may parse these decorated functions and generate corresponding nodes and edges within the execution graph.

The execution graph generator 104 may derive execution graphs from implementation patterns other than the ReAct pattern. In some embodiments, the execution graph generator 104 may support a chain-of-thought implementation pattern, where a sequence of reasoning steps is performed in a linear fashion with each step building upon the output of the previous step. In some embodiments, the execution graph generator 104 may support a tree-of-thought implementation pattern, where multiple reasoning paths are explored in parallel and the system selects among alternative conclusions based on evaluation criteria. In some embodiments, the execution graph generator 104 may support a map-reduce implementation pattern, where an input is divided into multiple portions, each portion is processed independently by parallel nodes, and the results are aggregated by a reduce node. The map-reduce pattern may enable efficient parallel processing of large datasets or complex queries that can be decomposed into independent sub-tasks.

The execution graph generator 104 may parse decorators and annotations within the human readable programming language code to identify different node types within the execution graph. In some embodiments, the human readable programming language code may include decorators that indicate flow definitions, dynamic blocks, and input/output blocks. The execution graph generator 104 may use the decorators to determine how to translate each function into a corresponding node within the execution graph.

The execution graph generated by the execution graph generator 104 may include nodes connected by directed edges. The directed edges may be labeled with relationship indicators that define data flow and dependencies between operations. In some embodiments, the relationship indicators may include labels such as previous value relationships, keyword argument relationships, and exposure relationships. The labeled edges may enable the execution engine 108 to understand how data flows between nodes during execution.

The execution graph generator 104 may generate execution graphs that support iterative or recursive structures. In some embodiments, the execution graph may include nodes with bidirectional connections that represent iterative relationships where the system 100 may repeatedly invoke an operation. The iterative structures may enable multi-hop reasoning patterns where a query initiates a process that requires multiple sequential processing steps before producing a result.

The execution graph may evolve during execution. The execution graph generator 104 may generate an initial execution graph structure, and the execution engine 108 may modify the execution graph as execution proceeds. In some embodiments, the execution graph may transform during runtime, where nodes containing expressions are evaluated and replaced with constant values. The evolution of the execution graph may enable the system 100 to optimize execution based on intermediate results.

The dependency analyzer 106 may communicate with the execution graph generator 104 and may analyze the execution graph to identify, based on the data dependencies between the plurality of nodes, independent nodes among the plurality of nodes that do not depend on each other. In some embodiments, the dependency analyzer 106 may traverse the execution graph to identify nodes that do not have data dependencies on each other. The dependency analyzer 106 may provide dependency information to the execution engine 108.

Two or more nodes may be considered independent when the output of one node is not required as an input to another node. The dependency analyzer 106 may determine that nodes at the same level within the execution graph that do not share data dependencies are independent nodes. In some embodiments, the dependency analyzer 106 may generate dependency information that specifies which nodes may be executed in parallel and which nodes require sequential execution due to data dependencies.

The dependency analyzer 106 may provide dependency information to the execution engine 108. The dependency information may include identification of independent nodes, ordering constraints for nodes with data dependencies, and relationships between node outputs and inputs. In some embodiments, the dependency information may include a mapping of nodes to execution groups, where nodes within the same execution group may be executed in parallel.

The validation module 114 may communicate with the execution graph generator 104 and the execution engine 108. The validation module 114 may validate the human readable programming language code against a plurality of permissible functions that are permitted to be executed. For example, the validation module 114 may detect whether the human readable programming language code contains third-party code, operating system calls, or file-system operations. The validation module 114 may enforce security constraints on the human readable programming language code prior to execution by the execution engine 108.

The validation module 114 may detect whether the human readable programming language code contains third-party code. In some embodiments, the validation module 114 may parse the human readable programming language code to identify import statements or references to external libraries. The validation module 114 may prohibit the human readable programming language code from including imports that introduce third-party code with unknown capabilities. By restricting imports, the validation module 114 may prevent the execution of code from external sources that have not been verified as safe for execution within the system 100.

In some embodiments, the validation module 114 may detect whether the human readable programming language code contains operating system calls. Operating system calls may include functions that interact with the underlying operating system, such as process management functions, system configuration functions, or network access functions. The validation module 114 may deny execution of human readable programming language code that includes operating system calls.

In some embodiments, the validation module 114 may detect whether the human readable programming language code contains file-system operations. File-system operations may include functions that read from, write to, create, delete, or modify files or directories on a storage medium. The validation module 114 may deny execution of human readable programming language code that includes file-system operations.

In some embodiments, the validation module 114 may maintain an allow list of functions that are permitted to be executed. The allow list may define a set of functions that have been determined to be secure by design. The validation module 114 may compare function calls within the human readable programming language code against the allow list to determine whether each function call is permitted. Function calls that do not appear on the allow list may be rejected by the validation module 114.

In some embodiments, the allow list of functions may include string manipulation functions such as concatenation, substring extraction, and case conversion. The allow list may include mathematical operations such as addition, subtraction, multiplication, division, and common mathematical functions. The allow list may include list operations such as appending elements, accessing elements by index, filtering, and mapping operations. The allow list may include dictionary operations such as key lookup, key-value insertion, and iteration over entries. In some embodiments, the allow list may include functions for invoking trained models within the system 100, where such functions are designed to operate within the controlled execution environment. The allow list may be maintained as a configuration file or data structure that is loaded by the validation module 114 during initialization. In some embodiments, the allow list may be updated by an administrator to add new permissible functions or remove functions that are no longer considered safe. The validation module 114 may update the allow list periodically or in response to an update signal to incorporate changes to the permissible functions.

The validation module 114 may provide security guarantees on the executed human readable programming language code. By parsing the human readable programming language code and validating the code against the plurality of permissible functions, the validation module 114 may ensure that only authorized operations are performed during execution. Accordingly, the validation module 114 may improve security and protect the computing environment from potentially harmful code execution.

The execution engine 108 may receive the execution graph and dependency information from the dependency analyzer 106 and may execute the independent nodes in parallel to process the request. The execution engine 108 may communicate with the memory 116. In some embodiments, the execution engine 108 may store a state of the execution graph to the memory 116, enabling features such as halting execution and continuing from the stored state.

The execution engine 108 may execute the independent nodes in parallel to process the request. By executing independent nodes in parallel rather than sequentially, the execution engine 108 may reduce the total time required to process the request. In some embodiments, the execution engine 108 may allocate separate processing resources to each independent node to enable concurrent execution.

The processing resources allocated by the execution engine 108 may include threads within a multi-threaded execution environment, processes within a multi-process execution environment, or distributed workers across multiple computing nodes. In some embodiments, the execution engine 108 may allocate threads from a thread pool to execute independent nodes concurrently within a single process. In some embodiments, the execution engine 108 may spawn separate processes to execute independent nodes, which may provide isolation between node executions. In some embodiments, the execution engine 108 may distribute independent nodes across distributed workers in a cluster computing environment to enable horizontal scaling of parallel execution. The execution engine 108 may employ load balancing strategies to distribute work among available processing resources. Load balancing strategies may include round-robin assignment, where nodes are assigned to resources in a rotating sequence, or load-aware assignment, where nodes are assigned to resources based on current utilization levels. In some embodiments, resource constraints may affect parallelization decisions made by the execution engine 108. When available processing resources are limited, the execution engine 108 may prioritize execution of nodes on a critical path within the execution graph or may batch multiple small nodes for execution on a single resource to reduce overhead.

The execution engine 108 may coordinate the parallel execution of independent nodes while respecting data dependencies identified by the dependency analyzer 106. The execution engine 108 may wait for a node to complete execution before executing subsequent nodes that depend on the output of the completed node. In some embodiments, the execution engine 108 may manage a queue of nodes that are ready for execution based on the completion status of predecessor nodes.

In some embodiments, the execution engine 108 may implement synchronization mechanisms for coordinating parallel execution of nodes. Synchronization mechanisms may include locks that prevent concurrent access to shared resources, semaphores that limit the number of concurrent operations, and barriers that synchronize execution at specific points within the execution graph. The execution engine 108 may use the synchronization mechanisms to prevent race conditions where multiple nodes attempt to access or modify shared data concurrently. In some embodiments, the execution engine 108 may implement deadlock detection and resolution mechanisms. Deadlock may occur when two or more nodes are waiting for resources held by each other, preventing any of the nodes from proceeding. The execution engine 108 may detect deadlock conditions by analyzing resource dependencies and may resolve deadlocks by terminating one or more nodes, releasing resources, or reordering execution. The synchronization mechanisms may be implemented using operating system primitives, language-level constructs, or distributed coordination services depending on the deployment architecture of the system 100.

The execution engine 108 may collect results from the parallel execution of independent nodes. In some embodiments, the execution engine 108 may aggregate outputs from multiple independent nodes to provide inputs to subsequent nodes in the execution graph. The execution engine 108 may track the completion status of each node and may proceed to execute dependent nodes once the required predecessor nodes have completed execution.

In some embodiments, the execution engine 108 may implement error handling and recovery mechanisms for node execution failures. When a node fails during execution, the execution engine 108 may capture error information including an error type, error message, and stack trace associated with the failure. The execution engine 108 may implement retry mechanisms that attempt to re-execute a failed node a configurable number of times before treating the failure as permanent. In some embodiments, the execution engine 108 may implement exponential backoff between retry attempts, where the delay between attempts increases with each successive retry. The execution engine 108 may implement fallback strategies for handling node failures. Fallback strategies may include substituting a default value for the output of a failed node, invoking an alternative node that performs a similar function, or skipping the failed node and continuing execution with downstream nodes that do not depend on the output of the failed node.

In some embodiments, errors may propagate through the execution graph according to configurable error propagation policies. An error propagation policy may specify that an error in one node causes all dependent nodes to be marked as failed or may specify that dependent nodes should attempt execution with partial inputs. The execution engine 108 may store error information in the memory 116 to enable post-execution analysis of failures.

In some embodiments, the execution engine 108 may implement timeout mechanisms for long-running nodes. The execution engine 108 may associate each node with a timeout value that specifies a maximum duration for node execution. When a node exceeds its timeout value, the execution engine 108 may terminate execution of the node and may treat the timeout as a failure. The timeout value may be configurable on a per-node basis or may be set globally for all nodes within the execution graph. In some embodiments, the execution engine 108 may implement resource quotas or limits for individual nodes or entire execution graphs. Resource quotas may specify maximum memory allocation, maximum CPU utilization, maximum network bandwidth, or maximum number of concurrent operations. When a node or execution graph exceeds its resource quota, the execution engine 108 may throttle execution, pause execution, or terminate execution depending on the configured policy. In some embodiments, the execution engine 108 may implement graceful degradation when resources are exhausted. Graceful degradation may include reducing the degree of parallelism, queuing nodes for later execution, or returning partial results when complete execution is not possible within resource constraints.

The execution engine 108 may dynamically optimize resource allocation based on real-time monitoring of node execution. The dynamic optimization may allow the execution engine 108 to respond to actual execution conditions rather than relying on static resource allocation. By reallocating processing resources among independent nodes based on detected deviations between planned and actual resource utilization, the execution engine 108 may improve overall system throughput and reduce resource waste.

The parallel execution of independent nodes by the execution engine 108 may provide measurable improvements in processing efficiency. In some embodiments, the parallel execution may reduce total processing time by a factor proportional to the number of independent nodes that can be executed concurrently. For example, when an execution graph includes four independent nodes that each require one second of processing time, sequential execution would require four seconds of total processing time, whereas parallel execution may complete all four nodes in approximately one second.

The memory 116 may communicate with the execution engine 108 and may be configured to store a state of the execution graph. The memory 116 may comprise various types of volatile and non-volatile memory. Volatile memory may include random access memory (RAM), dynamic random access memory (DRAM), or static random access memory (SRAM). Non-volatile memory may include flash memory, solid-state drives (SSDs), hard disk drives (HDDs), or other persistent storage media. In some embodiments, the memory 116 may comprise a combination of high-speed volatile memory for active execution state and non-volatile memory for persistent storage of execution graph states. In some embodiments, the memory 116 may comprise cloud-based storage or distributed storage systems that enable storage and retrieval of execution graph states across multiple geographic locations. The cloud-based storage may provide redundancy, fault tolerance, and scalability for storing large numbers of execution graph states. In some embodiments, the memory 116 may comprise a distributed file system or object storage system that enables efficient storage and retrieval of execution graph states across a cluster of storage nodes.

The translation of the human readable programming language code into an execution graph may support storing and restoring the execution graph to the memory 116. For example, the execution engine 108 may store the state of the execution graph to the memory 116 at various points during execution. The stored state may include node completion status, intermediate results produced by executed nodes, data values associated with edges between nodes, and execution context information.

In some embodiments, the execution engine 108 may halt execution of the execution graph and may later continue execution from the stored state. For example, the execution engine 108 may store the state of the execution graph to the memory 116 in response to a halt condition. The halt condition may include a request for external input, a resource constraint, or a predetermined checkpoint within the execution graph. After halting execution, the execution engine 108 may restore the stored state from the memory 116 and may resume execution from the point at which execution was halted.

In some embodiments, the memory 116 may enable human-in-the-loop functionality as part of execution. For example, the execution engine 108 may halt execution of the execution graph to await input from a user or external system. The execution engine 108 may store the state of the execution graph to the memory 116 prior to halting execution. After receiving the input, the execution engine 108 may restore the stored state from the memory 116 and may continue execution based on the received input and the stored state.

In some embodiments, the memory 116 may enable replaying parts of the execution graph with modifications. For example, the execution engine 108 may store the state of the execution graph to the memory 116 at a checkpoint within the execution graph. The execution engine 108 may restore the stored state from the memory 116 and may replay execution of a portion of the execution graph with modified parameters, modified input values, or modified node configurations. The ability to replay parts of the execution graph with modifications may enable debugging, testing, and optimization of execution workflows.

In some embodiments, the memory 116 may enable early return once there is a valid result before complete execution of the execution graph. For example, the execution engine 108 may determine that a valid result has been produced by a subset of nodes within the execution graph before all nodes have completed execution. The execution engine 108 may store the state of the execution graph to the memory 116 and may output the valid result through the output module 110 without waiting for remaining nodes to complete execution. The stored state may enable the execution engine 108 to resume execution of remaining nodes at a later time if additional results are needed.

In some embodiments, the execution engine 108 may implement caching of intermediate results to avoid redundant computation. For example, the execution engine 108 may store intermediate results produced by nodes in a cache and may retrieve cached results when the same node is invoked with identical inputs. The caching may reduce processing time by avoiding re-execution of nodes that have already been executed with the same inputs.

In some embodiments, the execution engine 108 may implement memoization strategies for repeated function calls with identical inputs. Memoization may store the mapping between function inputs and outputs, enabling the execution engine 108 to return cached outputs without re-executing the function when the same inputs are encountered. The cache may be stored in the memory 116 and may have a configurable size limit and eviction policy. Eviction policies may include least recently used (LRU), least frequently used (LFU), or time-based expiration.

In some embodiments, the execution engine 108 may store multiple states of the execution graph to the memory 116 at different points during execution. The multiple stored states may enable the execution engine 108 to restore execution to any of the stored points. The execution engine 108 may manage the stored states by associating each stored state with a timestamp, a checkpoint identifier, or other metadata that identifies the point in execution at which the state was stored.

In some embodiments, the system 100 may implement version control for execution graphs. The system 100 may store multiple versions of an execution graph in the memory 116, enabling tracking of changes to the execution graph over time. Each version may be associated with a version identifier, a timestamp, and metadata describing the changes from the previous version. In some embodiments, the system 100 may provide rollback capabilities to previous execution graph versions. The rollback capabilities may enable the system 100 to revert to a previous version of an execution graph when a newer version produces unexpected results or errors. In some embodiments, the system 100 may support A/B testing of different execution graph configurations. A/B testing may involve executing different versions of an execution graph for different requests and comparing the results to determine which version performs better according to defined metrics. The metrics may include processing time, resource utilization, result quality, or error rates.

The memory 116 may store the state of the execution graph in a format that preserves data dependencies between nodes. The stored state may include information about which nodes have completed execution, which nodes are pending execution, and which nodes are ready for execution based on the completion status of predecessor nodes. The dependency analyzer 106 may use the stored state to determine which independent nodes may be executed in parallel when execution resumes from the stored state.

In some embodiments, the system 100 may provide visualization tools for viewing execution graphs. The visualization tools may display the execution graph as a directed graph with nodes and edges, enabling users to understand the structure and data flow of the execution workflow. The visualization tools may highlight nodes that are currently executing, nodes that have completed execution, and nodes that are pending execution. In some embodiments, the system 100 may provide debugging interfaces for inspecting node states and intermediate results during or after execution. The debugging interfaces may enable users to set breakpoints at specific nodes, step through execution node by node, and inspect variable values and intermediate results at each step. In some embodiments, the system 100 may provide logging mechanisms for recording execution history. The logging mechanisms may record timestamps, node identifiers, input values, output values, resource utilization, and error information for each node execution. The logged information may be stored in the memory 116 and may be retrieved for post-execution analysis, performance optimization, or compliance auditing.

The output module 110 may communicate with the execution engine 108 and may output a result of a request based on the parallel execution of the independent nodes. The output module 110 may receive the result from the execution engine 108 after the execution graph has been fully processed. In some embodiments, the output module 110 may format the result for presentation to a user or for transmission to another system.

In some embodiments, the output module 110 may aggregate results from multiple nodes within the execution graph to produce an output. For example, the output module 110 may receive intermediate results from the execution engine 108 and combine the intermediate results to generate the result of the request. The output module 110 may perform post-processing operations on the result before outputting the result.

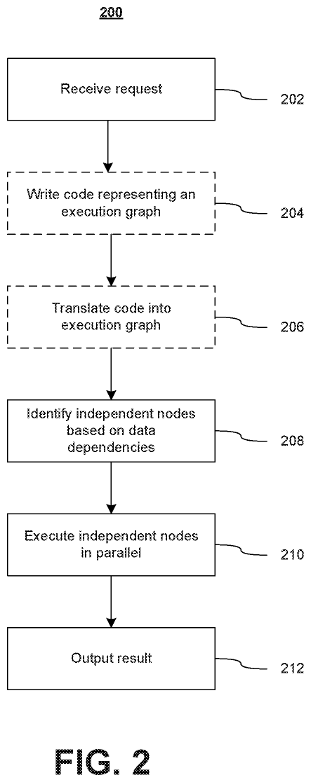

FIG. 2 illustrates a flowchart for a method 200 for generating and executing parallel execution graphs using human readable programming language code, consistent with disclosed embodiments. The method 200 may be performed by the system 100 described with reference to FIG. 1. Furthermore, a non-transitory computer readable medium may include instructions that when executed by one or more processing devices cause the one or more processing devices to perform the method 200. In some embodiments, one or more steps of the method 200 may be omitted.

At a step 202, the system 100 receives a request. The request may comprise a task that requires processing by one or more models within an AI system. In some embodiments, the request may involve complex execution workflows that require multiple calls to models due to different capabilities of the models. In some embodiments, the request may require multi-hop reasoning, where the system 100 performs multiple sequential processing steps to arrive at a result.

The request may be received from various sources. In some embodiments, the request may be received from a user interface, such as a graphical user interface, a command-line interface, or a conversational interface. In some embodiments, the request may be received from an application programming interface (API) call made by an external system or application. In some embodiments, the request may be received from a scheduled task that triggers execution at predetermined times or intervals. In some embodiments, the request may be received from an event trigger that initiates execution in response to a detected event or condition. The request may be formatted in various ways. In some embodiments, the request may comprise natural language text that describes the task to be performed. In some embodiments, the request may comprise a structured query that specifies parameters and constraints for the task. In some embodiments, the request may comprise a JSON payload, an XML payload, or other structured data format that defines the task and associated parameters. In some embodiments, the request may comprise a document summarization task where the system 100 processes a document and generates a summary. In some embodiments, the request may comprise a multi-step question answering task where the system 100 retrieves information from multiple sources and synthesizes an answer based on the retrieved information. In some embodiments, the request may comprise a data analysis pipeline where the system 100 processes input data through multiple transformation and analysis steps to produce analytical results.

Other examples of tasks may include code generation tasks where the system 100 generates programming code based on a natural language description, translation tasks where the system 100 translates content between languages, and classification tasks where the system 100 categorizes input data into predefined categories. The complexity of the task may determine the structure of the execution graph generated by the execution graph generator 104.

At a step 204, the system 100 writes, in a human readable programming language, code representing an execution graph for the request. In some embodiments, the human readable programming language code may comprise Python programming language code. The human readable programming language code may support a functional application programming interface (API) without side effects, meaning that calls to functions can be replaced by their return value because functions do not alter any state outside of their own scope.

In some embodiments, the system 100 generates or writes the code representing the execution graph for the request using a trained model (e.g., trained model 112). In some embodiments, the trained model may comprise a large language model (LLM). The trained model may be configured based on training data comprising one or more open-source repositories and examples of human readable programming language code. LLMs may be effective at generating the human readable programming language code because LLMs are trained on datasets sourced from the internet, which include open-source repositories and coding examples. In some embodiments, the step 204 may be omitted.

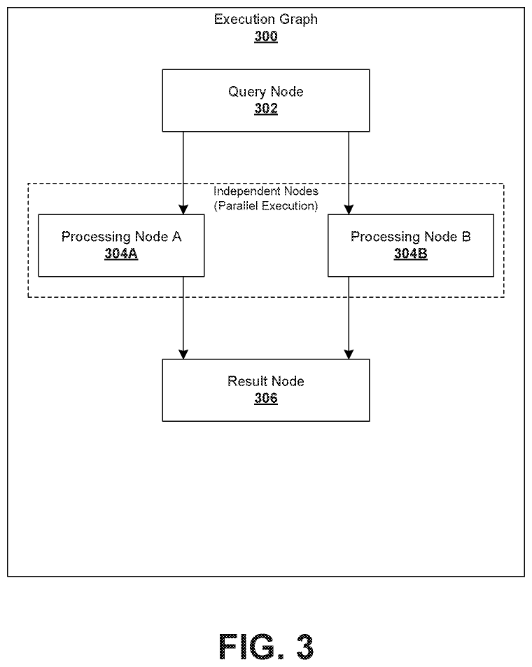

At a step 206, the system 100 translates the human readable programming language code into an execution graph. For example, the execution graph generator 104 may receive the human readable programming language code from the code input module 102 and may translate the human readable programming language code into the execution graph. The execution graph may comprise a plurality of nodes representing function calls and data dependencies between the plurality of nodes. The translation process may convert the human readable programming language code into a graph structure where relationships between operations are explicitly defined. While in the human readable programming language code representation the data dependencies between different functions may not always be clear, the execution graph representation may define relationships based on data dependencies. An example of an execution graph is discussed below in connection with FIG. 3. In some embodiments, the step 206 may be omitted.

At a step 208, the system 100 identifies independent nodes based on data dependencies within the execution graph. For example, the dependency analyzer 106 may analyze the execution graph to identify, based on the data dependencies between the plurality of nodes, independent nodes among the plurality of nodes that do not depend on each other. Two or more nodes may be considered independent when the output of one node is not required as an input to another node. The dependency analyzer 106 may determine that nodes at the same level within the execution graph that do not share data dependencies are independent nodes. The dependency analyzer 106 may generate dependency information that specifies which nodes may be executed in parallel and which nodes require sequential execution due to data dependencies.

At a step 210, the system 100 executes the independent nodes in parallel. For example, the execution engine 108 may receive the execution graph and dependency information from the dependency analyzer 106 and may execute the independent nodes in parallel to process the request. In some embodiments, the execution engine 108 may allocate separate processing resources to each independent node to enable concurrent execution. The execution engine 108 may coordinate the parallel execution of independent nodes while respecting data dependencies identified by the dependency analyzer 106. The execution engine 108 may wait for a node to complete execution before executing subsequent nodes that depend on the output of the completed node.

At a step 212, the system 100 outputs the result. For example, the output module 110 may output a result of the request based on the parallel execution of the independent nodes. The output module 110 may receive the result from the execution engine 108 after the execution graph has been fully processed. The output module 110 may format the result for presentation to a user or for transmission to another system. For example, the result may be transmitted to a device (e.g., a handheld device, computing device, etc.) for display on a display device. The display device may comprise a liquid crystal display (LCD), a light-emitting diode (LED) display, an organic light-emitting diode (OLED) display, or other display technology.

In some embodiments, the output module 110 may transmit the result to a mobile device such as a smartphone or tablet for display on a touchscreen display. In some embodiments, the output module 110 may transmit the result to a desktop computer or laptop computer for display on a monitor. The output module 110 may format the result according to display characteristics of the target display device, such as screen resolution, aspect ratio, or color capabilities. In some embodiments, the output module 110 may generate a graphical representation of the result, such as a chart, graph, or visualization, for display on the display device. In some embodiments, the output module 110 may generate a textual representation of the result for display in a user interface element such as a text box, dialog window, or notification. In some embodiments, the output module 110 may transmit the result over a network connection to a remote display device or may provide the result to a local display device connected to or in communication with the system 100.

In some embodiments, the output module 110 may transmit the result to an audio output device for audible presentation. The audio output device may comprise a speaker, headphones, earbuds, or a smart speaker device. The output module 110 may convert the result into synthesized speech using a text-to-speech engine and may transmit the synthesized speech to the audio output device. In some embodiments, the output module 110 may transmit the result to a wearable device such as a smartwatch, fitness tracker, or augmented reality headset. The wearable device may present the result through a combination of visual, auditory, or haptic feedback.

In some embodiments, the output module 110 may transmit the result to a server or cloud computing platform for storage or further processing. The output module 110 may transmit the result over a network connection using protocols such as HTTP, HTTPS, WebSocket, or message queue protocols. In some embodiments, the output module 110 may transmit the result to an application programming interface (API) endpoint that receives the result and provides the result to downstream systems or applications. In some embodiments, the output module 110 may transmit the result to an Internet of Things (IoT) device or smart home device. The IoT device may include smart thermostats, smart lighting systems, smart appliances, or home automation controllers. The output module 110 may format the result as a command or configuration update for the IoT device.

FIG. 3 illustrates an execution graph 300 depicting parallel execution of independent nodes, consistent with the disclosed embodiments. The execution graph 300 may represent a structure generated by the execution graph generator 104 after translating human readable programming language code, as discussed in the step 206 above. The execution graph 300 may include a plurality of nodes connected by directed edges that define data flow and dependencies between operations. For example, the execution graph 300 may include a query node 302 positioned at the top of the execution graph 300. The query node 302 may represent an initial input or request to the system 100. In some embodiments, the query node 302 may receive a request to perform a task and initiates the execution flow through the execution graph 300. The query node 302 may provide data to subsequent nodes within the execution graph 300.

As shown in FIG. 3, the execution graph 300 may include a processing node A 304A and a processing node B 304B positioned at the same level within the execution graph 300. The processing node A 304A and the processing node B 304B may be identified as independent nodes capable of parallel execution. The dependency analyzer 106 may determine that the processing node A 304A and the processing node B 304B are independent nodes because the output of the processing node A 304A is not required as an input to the processing node B 304B, and the output of the processing node B 304B is not required as an input to the processing node A 304A. In some embodiments, the processing node A 304A and the processing node B 304B may each receive data from the query node 302 and perform separate processing operations on the received data.

As shown in FIG. 3, the execution graph 300 may include a result node 306 positioned at the bottom of the execution graph 300. The result node 306 may receive outputs from both the processing node A 304A and the processing node B 304B. In some embodiments, the result node 306 may aggregate or combine the outputs from the processing node A 304A and the processing node B 304B to produce a final result of the request.

The arrows shown in the execution graph 300 of FIG. 3 may indicate data flow from the query node 302 to the processing node A 304A and the processing node B 304B. The arrows may further indicate data flow from the processing node A 304A and the processing node B 304B to the result node 306. The directed edges may define the data dependencies between the plurality of nodes within the execution graph 300.

The execution engine 108 may execute the processing node A 304A and the processing node B 304B in parallel based on the dependency information provided by the dependency analyzer 106. By executing the processing node A 304A and the processing node B 304B concurrently rather than sequentially, the execution engine 108 may reduce the total time required to process the request. The execution engine 108 may wait for both the processing node A 304A and the processing node B 304B to complete execution before executing the result node 306, because the result node 306 depends on the outputs of both the processing node A 304A and the processing node B 304B.

In some embodiments, the execution graph 300 may represent a portion of a larger execution graph structure. The execution graph 300 may be a sub-graph within a more complex execution workflow that includes additional nodes and dependencies. The structure of the execution graph 300 may enable the system 100 to identify parallelization opportunities where multiple independent nodes may be executed concurrently to reduce processing time.

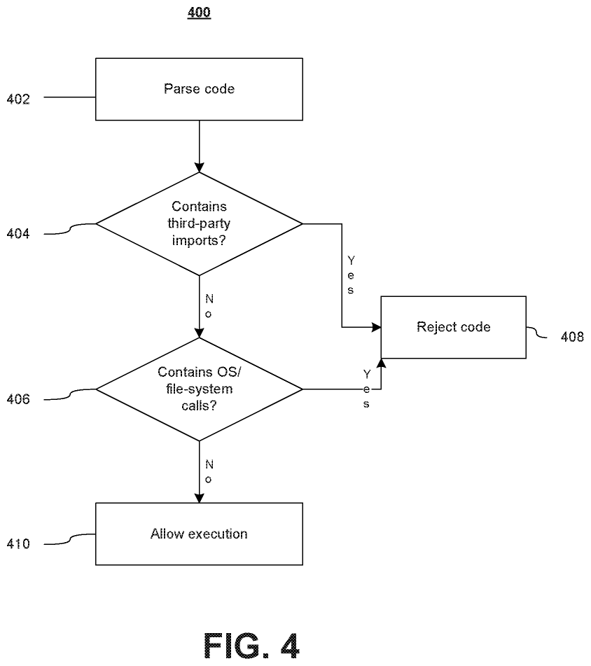

FIG. 4 illustrates a flowchart for a method 400 for validating human readable programming language code prior to execution, consistent with the disclosed embodiments. The method 400 may be performed by the validation module 114 described with reference to FIG. 1. The method 400 may provide a validation process that checks the human readable programming language code against permissible functions before execution by the execution engine 108 in the step 210.

At a step 402, the system 100 parses the human readable programming language code. In some embodiments, the validation module 114 may analyze the structure of the human readable programming language code to identify function calls, import statements, and other code constructs.

At a decision 404, the validation module 114 determines whether the human readable programming language code contains third-party imports. The validation module 114 may examine import statements within the human readable programming language code to identify references to external libraries or modules. In some embodiments, the validation module 114 may compare identified imports against an allow list of permitted imports. Third-party imports may introduce code with unknown capabilities that have not been verified as safe for execution within the system 100. If the human readable programming language code contains third-party imports (“Yes” branch from the decision 404), the method 400 proceeds to a step 408. If the human readable programming language code does not contain third-party imports (“No” branch from the decision 404), the method 400 proceeds to a decision 406.

At the decision 406, the validation module 114 detects whether the human readable programming language code contains operating system calls or file-system operations. Operating system calls may include functions that interact with the underlying operating system, such as process management functions, system configuration functions, or network access functions. File-system operations may include functions that read from, write to, create, delete, or modify files or directories on a storage medium. The validation module 114 may examine function calls within the human readable programming language code to identify operating system calls or file-system operations. If the human readable programming language code contains operating system calls or file-system operations (“Yes” branch from the decision 406), the method 400 proceeds to a step 408. If the human readable programming language code does not contain operating system calls or file-system operations (“No” branch from the decision 406), the method 400 proceeds to a step 410.

At the step 408, the system 100 rejects the human readable programming language code. The validation module 114 may prevent the human readable programming language code from being executed by the execution engine 108. In some embodiments, the validation module 114 may generate an error message or notification indicating that the human readable programming language code failed validation. The rejection at the step 408 may occur when the human readable programming language code contains third-party imports detected at the decision 404 or when the human readable programming language code contains operating system calls or file-system operations detected at the decision 406.

At the step 410, the system 100 allows execution of the human readable programming language code. The validation module 114 may indicate to the execution graph generator 104 or the execution engine 108 that the human readable programming language code has passed validation. In some embodiments, the validation module 114 may provide an authorization signal that permits the execution engine 108 to proceed with execution of the execution graph derived from the human readable programming language code. The human readable programming language code that reaches the step 410 may be considered to conform to one or more permissible functions that are permitted to be executed.

The method 400 may enable security guarantees on the executed human readable programming language code. By detecting third-party imports at the decision 404 and operating system calls or file-system operations at the decision 406, the method 400 may ensure that only human readable programming language code meeting defined criteria proceeds to execution at the step 410. The validation process provided by the method 400 may enable the system 100 to execute human readable programming language code generated or written by the trained model 112 or received from external sources while maintaining a controlled execution environment.

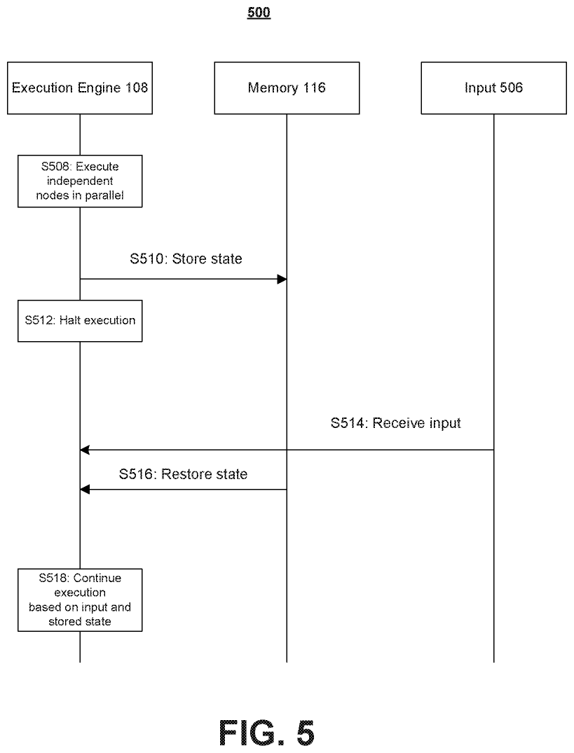

FIG. 5 illustrates a sequence diagram 500 representing a state storage and restoration process for execution graph management, consistent with the disclosed embodiments. The sequence diagram 500 may depict interactions between the execution engine 108, the memory 116, and an input 506, and illustrate an example of steps involved in executing, halting, and resuming an execution graph.

The sequence diagram 500 may begin at a step S508, where the execution engine 108 executes independent nodes in parallel. For example, the execution engine 108 may receive the execution graph and dependency information from the dependency analyzer 106 and may execute independent nodes concurrently based on the identified data dependencies. By executing independent nodes in parallel, the execution engine 108 may reduce the total time required to process a request.

At a step S510, the execution engine 108 stores a state of the execution graph. The execution engine 108 may store the state to the memory 116. The stored state may include node completion status, intermediate results produced by executed nodes, data values associated with edges between nodes, and execution context information. The stored state may preserve data dependencies between nodes, enabling the execution engine 108 to determine which independent nodes may be executed in parallel when execution resumes. In some embodiments, while executing the independent nodes in parallel to process the request, the execution engine 108 may store a state of the execution graph to a memory (e.g., the memory 116).

At a step S512, the execution engine 108 halts execution of the execution graph. The execution engine 108 may cease executing the independent nodes in parallel to process the request after storing the state of the execution graph. In some embodiments, the execution engine 108 may halt execution in response to a halt condition. The halt condition may include a request for external input, a resource constraint, or a predetermined checkpoint within the execution graph.

At a step S514, the execution engine 108 receives an input (e.g., input 506). For example, the input 506 may comprise an input from a user or an input from an external system. In some embodiments, the input 506 may provide a decision, a modification, or additional data that affects subsequent execution of the execution graph. The step S514 may enable human-in-the-loop functionality, where execution pauses to await external input before continuing.

In some embodiments, the human-in-the-loop functionality may be used for approval workflows where execution pauses to await approval from a user before proceeding with operations that have significant consequences. In some embodiments, the human-in-the-loop functionality may be used for disambiguation requests where the system 100 encounters ambiguous input and requests clarification from a user before continuing execution. In some embodiments, the human-in-the-loop functionality may be used for quality review checkpoints where intermediate results are presented to a user for review and validation before the execution graph proceeds to subsequent processing steps. The input provided by the user may include approval or rejection decisions, selection among alternative options presented by the system 100, corrections or modifications to intermediate results, additional information or context to guide subsequent execution, or instructions to modify the execution graph structure. In some embodiments, the input 506 may include parameters that affect how remaining nodes in the execution graph are executed, such as quality thresholds, resource limits, or output format preferences.

At a step S516, the memory 116 restores the previously stored state to the execution engine 108. The memory 116 may retrieve the stored state and may provide the stored state to the execution engine 108. The restoration at the step S516 may enable the execution engine 108 to resume processing from the point at which execution was halted at the step S512.

At a step S518, the execution engine 108 may continue to execute the independent nodes in parallel to process the request based on the input and the stored state. For example, the execution engine 108 may proceed with execution of the execution graph from where execution was halted, incorporating any modifications or decisions provided through the input 506. The execution engine 108 may continue to execute independent nodes in parallel while respecting data dependencies identified by the dependency analyzer 106.

The sequence diagram 500 may illustrate the interaction flow between the execution engine 108, the memory 116, and the input 506 during the state management process. The state storage and restoration process may enable features such as human-in-the-loop functionality, where execution pauses to await external input before continuing with the stored execution state. In some embodiments, the state storage and restoration process may enable replaying parts of the execution graph with modifications. In some embodiments, the state storage and restoration process may enable early return once there is a valid result before complete execution of the execution graph.

The system 100 may provide traceability of the execution graph throughout the execution process. Traceability may include tracking resource utilization and intermediate results associated with nodes in the execution graph. The execution engine 108 may monitor resource consumption during execution of the plurality of nodes and may record resource utilization data associated with each node. Resource utilization may include processing time consumed by each node, memory allocation associated with each node, network bandwidth consumed during execution, and computational resources allocated to parallel execution of independent nodes. The execution engine 108 may track planned resource utilization values and actual resource utilization values for each node within the execution graph. Planned resource utilization values may be determined prior to execution based on historical data, node type, or estimated complexity of the function call represented by the node.

In some embodiments, the system 100 may track at least one intermediate result associated with at least one of the plurality of nodes. Intermediate results may comprise outputs produced by nodes during execution of the execution graph before the result is generated. The execution engine 108 may store intermediate results in the memory 116 as nodes complete execution. In some embodiments, the execution engine 108 may associate each intermediate result with the node that produced the intermediate result and with metadata describing the intermediate result.

The intermediate results may include data values, data structures, model outputs, or other information produced by function calls represented by nodes within the execution graph. The execution engine 108 may track the type of each intermediate result, where the type indicates the data type or structure of the intermediate result. In some embodiments, the execution engine 108 may compare a planned type of an intermediate result with an actual type of the intermediate result produced during execution.

In some embodiments, the system 100 may modify the execution graph based on a deviation between a planned resource utilization and an actual resource utilization. The execution engine 108 may detect when actual resource utilization for a node or group of nodes deviates from planned resource utilization by a threshold amount. In response to detecting the deviation, the execution engine 108 may modify the execution graph to adjust resource allocation, to reschedule node execution, or to alter the structure of the execution graph. In some embodiments, the modification may include reallocating processing resources among independent nodes to balance resource consumption.

The threshold amount may be defined as a percentage deviation from the planned resource utilization. In some embodiments, the threshold amount may comprise a deviation of at least 10%, at least 20%, at least 50%, or at least 100% from the planned resource utilization. The threshold amount may vary based on the type of resource being monitored. For example, a threshold amount for processing time deviation may differ from a threshold amount for memory allocation deviation.

In some embodiments, the threshold amount may be configurable by a user or administrator of the system 100. The threshold amount may be specified as an absolute value, such as a number of milliseconds for processing time or a number of bytes for memory allocation. The threshold amount may be specified as a relative value, such as a percentage or ratio relative to the planned resource utilization.

The threshold amount may be determined dynamically based on historical execution data. The execution engine 108 may analyze resource utilization patterns from previous executions of similar nodes or execution graphs and may set the threshold amount based on observed variance in resource consumption. In some embodiments, the threshold amount may be set to a multiple of a standard deviation calculated from historical resource utilization data.

In some embodiments, different threshold amounts may be applied to different nodes within the execution graph. Nodes representing complex function calls or calls to trained models may have higher threshold amounts than nodes representing simple data transformations. The execution engine 108 may associate each node with a corresponding threshold amount based on the node type, the function call represented by the node, or historical performance data for the node.

In some embodiments, the system 100 may modify the execution graph based on a deviation between a planned type of at least one intermediate result and an actual type of the at least one intermediate result. For example, the execution engine 108 may detect when an intermediate result produced by a node has a type that differs from an expected type. In response to detecting the type deviation, the execution engine 108 may modify the execution graph to handle the unexpected type. In some embodiments, the modification may include inserting additional nodes to perform type conversion, modifying downstream nodes to accept the actual type, or selecting an alternative execution path within the execution graph.

The traceability provided by the system 100 may enable monitoring and debugging of execution workflows. By tracking resource utilization and intermediate results, the system 100 may identify nodes that consume more resources than expected or that produce unexpected outputs. The tracked information may be used to optimize future execution of similar execution graphs or to identify areas where the execution graph may be improved.

In some embodiments, the execution engine 108 may generate traceability records that associate each node with resource utilization data and intermediate results. The traceability records may be stored in the memory 116 and may be accessed for analysis after execution of the execution graph completes. The traceability records may enable reconstruction of the execution flow and identification of deviations that occurred during execution.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented method, comprising:
receiving a request to perform a task;
writing, in a human readable programming language, code representing an execution graph for the request, wherein the human readable programming language code supports a functional application programming interface;
translating the human readable programming language code into the execution graph, wherein the execution graph comprises a plurality of nodes representing function calls and data dependencies between the plurality of nodes;
identifying, based on the data dependencies between the plurality of nodes, independent nodes among the plurality of nodes that do not depend on each other;
executing the independent nodes in parallel to process the request; and
outputting a result of the request based on the parallel execution of the independent nodes.

2. The computer-implemented method of claim 1, wherein a trained model generates the human readable programming language code.

3. The computer-implemented method of claim 2, wherein the trained model comprises a large language model.

4. The computer-implemented method of claim 2, wherein the trained model is configured based on training data comprising one or more open-source repositories.

5. The computer-implemented method of claim 2, wherein the trained model is configured based on training data comprising examples of human readable programming language code.

6. The computer-implemented method of claim 1, wherein the human readable programming language code comprises Python programming language code.

7. The computer-implemented method of claim 1, further comprising prior to executing the independent nodes in parallel to process the request, validating the human readable programming language code against a plurality of permissible functions that are permitted to be executed.

8. The computer-implemented method of claim 7, wherein validating the human readable programming language code against the plurality of permissible functions that are permitted to be executed comprises:
detecting whether the human readable programming language code contains third-party code; and
detecting whether the human readable programming language code contains operating system calls or file-system operations.

9. The computer-implemented method of claim 7, wherein a trained model validates the human readable programming language code against the plurality of permissible functions that are permitted to be executed.

10. The computer-implemented method of claim 1, further comprising modifying the execution graph based on a deviation between a planned resource utilization and an actual resource utilization.

11. The computer-implemented method of claim 1, further comprising tracking at least one intermediate result associated with at least one of the plurality of nodes.

12. The computer-implemented method of claim 11, further comprising modifying the execution graph based on a deviation between a planned type of the at least one intermediate result and an actual type of the at least one intermediate result.

13. The computer-implemented method of claim 1, further comprising:
while executing the independent nodes in parallel to process the request, storing a state of the execution graph to a memory;
after storing the state of the execution graph to the memory, ceasing to execute the independent nodes in parallel to process the request;
after ceasing to execute the independent nodes in parallel to process the request, receiving an input; and
continuing to execute the independent nodes in parallel to process the request based on the input and the stored state.

14. A non-transitory computer readable medium including instructions that when executed by one or more processing devices cause the one or more processing devices to perform a method including:
receiving a request to perform a task;
writing, in a human readable programming language, code representing an execution graph for the request, wherein the human readable programming language code supports a functional application programming interface;
translating the human readable programming language code into the execution graph, wherein the execution graph comprises a plurality of nodes representing function calls and data dependencies between the plurality of nodes;
identifying, based on the data dependencies between the plurality of nodes, independent nodes among the plurality of nodes that do not depend on each other;
executing the independent nodes in parallel to process the request; and
outputting a result of the request based on the parallel execution of the independent nodes.

15. The non-transitory computer readable medium of claim 14, wherein a trained model generates the human readable programming language code.

16. The non-transitory computer readable medium of claim 15, wherein the trained model comprises a large language model.

17. The non-transitory computer readable medium of claim 15, wherein the trained model is configured based on training data comprising one or more open-source repositories.

18. The non-transitory computer readable medium of claim 15, wherein the trained model is configured based on training data comprising examples of human readable programming language code.

19. The non-transitory computer readable medium of claim 14, wherein the human readable programming language code comprises Python programming language code.

20. The non-transitory computer readable medium of claim 14, the method further comprising prior to executing the independent nodes in parallel to process the request, validating the human readable programming language code against a plurality of permissible functions that are permitted to be executed.

21. The non-transitory computer readable medium of claim 20, wherein validating the human readable programming language code against the plurality of permissible functions that are permitted to be executed comprises:
detecting whether the human readable programming language code contains third-party code; and
detecting whether the human readable programming language code contains operating system calls or file-system operations.

22. The non-transitory computer readable medium of claim 20, wherein a trained model validates the human readable programming language code against the plurality of permissible functions that are permitted to be executed.

23. The non-transitory computer readable medium of claim 14, the method further comprising modifying the execution graph based on a deviation between a planned resource utilization and an actual resource utilization.

24. The non-transitory computer readable medium of claim 14, the method further comprising tracking at least one intermediate result associated with at least one of the plurality of nodes.

25. The non-transitory computer readable medium of claim 24, the method further comprising modifying the execution graph based on a deviation between a planned type of the at least one intermediate result and an actual type of the at least one intermediate result.

26. The non-transitory computer readable medium of claim 14, the method further comprising:
while executing the independent nodes in parallel to process the request, storing a state of the execution graph to a memory;
after storing the state of the execution graph to the memory, ceasing to execute the independent nodes in parallel to process the request;
after ceasing to execute the independent nodes in parallel to process the request, receiving an input; and
continuing to execute the independent nodes in parallel to process the request based on the input and the stored state.
